(19) United States
(12) Patent Application Publication
(10) Pub. No.: US 2004/0258074 A1
(43) Pub. Date: Dec. 23, 2004

(54) Method and apparatus for allocating addresses in integrated zero-configured and manually configured networks

(76) Inventors: Aidan Michael Williams, Chifley (AU); Arthur Dimitrelis, Auburn (AU)

Correspondence Address: Daniel K. Nichols, Motorola, Inc. - Law Department, 1303 E. Algonquin Road, Schaumburg, IL, 60196, US

(21) Appl. No.: 10/600,076

(22) Filed: Jun. 20, 2003

(51) Int. Cl. H04L 12/28

(52) U.S. Cl. 370/395.5; 370/351

(57) ABSTRACT

A method and an apparatus for allocating an address in an integrated network comprising at least one zero-configuration network component and one or more configured network components are disclosed. The method comprises the steps of obtaining address reachability information relating to configured components (110), automatically allocating an address that avoids an addressing conflict with the configured components (120), and providing the allocated address to a routing protocol serving the configured network components (130). A network including the foregoing apparatus is also disclosed. The apparatus or network device typically comprises a zero-configuration router modified to perform the foregoing method steps.

### FIELD OF THE INVENTION

The present invention relates to communication networks and more particularly to allocating addresses in an integrated network.

### BACKGROUND

Computers connected to networks such as the Internet are identified and located by means of associated Internet Protocol (IP) addresses that are either statically or dynamically allocated. Key devices on the Internet such as Web servers and mail servers have static IP addresses that do not change and are thus located at the same virtual “location”. Most computers, however, are dynamically allocated a different IP address each time a connection to the Internet is established. Typical protocols for dynamic address assignment include Dynamic Host Configuration Protocol (DHCP) and Bootstrap Protocol (BOOTP). Computing clients commonly use DHCP to communicate with an IP configuration server. Routers use routing protocols such as Routing Information Protocol (RIP) and Open Shortest Path First (OSPF) to communicate with adjacent routers in the network to inform each other of which ranges of addresses or address prefixes in a network are reachable and which paths should be taken by packets traveling through the network. Information communicated via a routing protocol is typically inserted, deleted, or updated in routing tables as particular routes change over time. OSPF is a commonly used Internet routing protocol that requires manual configuration.

Numerous common protocols require manual configuration and maintenance by administrative staff, which requires knowledge of network administration skills. This is generally unacceptable for emerging networks such as home networks, automobile networks, airplane networks and ad-hoc networks. Such networks may consist of nothing more than two isolated laptop personal computers connected via a wireless local area network (LAN).

Moreover, networks commonly undergo change during their lifetime. For example, hosts may be added and removed, network segments may be re-arranged and devices may change name or run different services. In a configured network, an administrator ensures that the protocol parameters are updated to reflect such changes and is responsible for ensuring network consistency.

A disadvantage of existing networks is that such networks are either totally self-configured or totally manually configured.

### SUMMARY

According to aspects of the present invention, there are provided a method and an apparatus for allocating addresses in integrated zero-configured and manually configured networks. The method comprises the steps of obtaining address reachability information relating to the configured components, automatically allocating a network address that avoids an addressing conflict with the reachability information relating to the configured components, and providing the allocated address to a routing protocol serving the configured network components. The apparatus may comprise a zero-configuration router.

The addresses allocated to the configured components of the network may be obtained by surveillance of a routing protocol. Alternatively, a list of addresses already in use can be imported from an address allocation mechanism in the network. An allocated address may comprise an IP address or an IP subnet prefix and can be exported as a reachable IP address or IP subnet prefix in routing protocols such as RIP and OSPF.

The method can comprise the further step of detecting address collisions in the network.

According to another aspect of the present invention, there is provided a communication network comprising a plurality of network components including at least one configured component having a manually allocated address and at least one zero-configured component. Addresses automatically allocated to the at least one zero-configured component are selected to avoid address conflicts with the manually allocated addresses.

The manually allocated addresses can be obtained from a configured routing protocol such as Routing Information Protocol (RIP) or Open Shortest Path First (OSPF), or imported from a configured address allocation mechanism or protocol such as Dynamic Host Configuration Protocol (DHCP) or Bootstrap Protocol (BOOTP). Addresses allocated automatically in the at least one zero-configured component are exported as reachability information into a routing protocol such as Routing Information Protocol (RIP) or Open Shortest Path First (OSPF). The reachability information for the at least one zero-configured component typically comprises an IP address or an IP subnet prefix. The zero-configured component typically comprises a self-configured or automatically configured router.

### BRIEF DESCRIPTION OF THE DRAWINGS

Embodiments of the present invention are described hereinafter, by way of example only, with reference to the accompanying drawings in which:

FIG. 1 is a flow diagram of a method for allocating addresses in integrated zero-configured and manually configured networks;

FIG. 2 is a flow diagram showing additional detail of step 110 of FIG. 1;

FIG. 3 is a flow diagram showing additional detail of step 120 of FIG. 1;

FIG. 4 is a flow diagram showing additional detail of step 130 of FIG. 1;

FIG. 5 is a diagram of a networking environment showing configured and zero-configured routers; and.

FIG. 6 is a block diagram of a network apparatus or device with which embodiments of the present invention can be practised.

### DETAILED DESCRIPTION

Methods and devices are described hereinafter with specific reference to the Internet and the Internet Protocol (IP). However, embodiments of the present invention are not intended to be limited in this manner since the principles described hereinafter have general applicability to other types of communication networks and network protocols. For example, embodiments of the present invention enable network components or devices that are not “zero-configuration aware”, such as legacy devices, to co-exist with zero-configuration network elements in both enterprise and home networks. Such networks include, but are not limited to, local area networks (LAN's), wide area networks (WAN's), wireless networks and private networks.

Standard internet routers are manually configured in that parameters such as address prefixes assigned to links are typically entered by an operator during manual configuration of the router. Configured or manually configured network protocols such as OSPF, RIP and DHCP require operator configuration for reliable operation. In particular, configuration of parameters such as address prefixes, host addresses and timer values by an operator is necessary.

Zero-configuration, auto-configured, or self-configured routers are standard internet routers that are additionally capable of automatically assigning addresses or address prefixes to network links.

A zero-configuration network is a set of links connected by zero-configuration routers that are automatically assigned address prefixes. Packets are forwarded between the links by the zero-configuration routers.

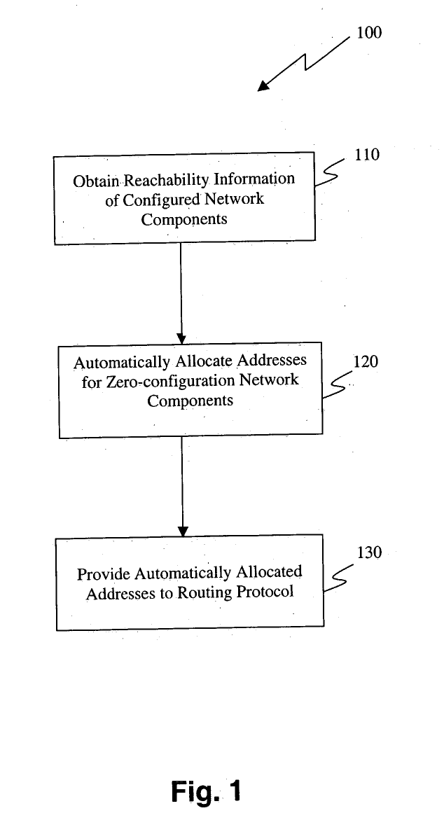

FIG. 1 is a flow diagram of a method for allocating addresses in integrated zero-configured and manually configured networks.

At step 110, reachability information relating to configured network components is obtained from various sources including:

“Snooping” or performing surveillance on configured routing protocols such as Integrated Intermediate System to Intermediate System (ISIS), Routing Information Protocol (RIP) and Open Shortest Path First (OSPF); and

Importing address allocation information from address allocation protocols such as Dynamic Host Configuration Protocol (DHCP) and Bootstrap Protocol (BOOTP).

It should be noted that the above list of routing protocols is not exhaustive and that snooping can be performed on other routing protocols, including new and proprietary routing protocols. Routing protocols distribute information relating to reachable addresses in a network. A network apparatus or device that wishes to avoid manually configured network prefixes, such as an zero-configuration router, can snoop or listen in on routing protocol messages broadcast during normal operation to determine which address prefixes are already in use in a configured network. This method relies on the assumption that addresses listed as reachable by the routing protocol are allocated and ignores default routes or other routes of last resort. Thereafter, the zero-configuration router avoids the address ranges associated with the prefixes already in use when automatically allocating a network address for each auto-configured network interface.

Routers typically advertise the reachability of address ranges (i.e., address prefixes). By learning the address ranges that a router is advertising as reachable, a device can infer which individual addresses have been manually configured. For example, if a router advertises that the prefix 192.168.100/254 is reachable, a zero-configuration device augmented to practise an embodiment of the present invention can determine that addresses 192.168.100.1, 192.168.100.2, 192.168.100.3, and so on, up to 192.168.100.254 have been manually configured.

Information relating to a particular address prefix currently in use is preserved so that a zero-configuration router can defend an automatically allocated address prefix when a conflict with another router is detected. The exact nature of the defence mechanism is defined by the particular zero-configuration protocol. A conflict with a manually configured address prefix cannot be defended and the zero-configuration router must switch to a new non-conflicting prefix as soon as possible. Information facilitating collision detection such as the unique physical address of the allocating router (e.g., Ethernet MAC, or EUI-64) is also preserved.

Zero-configuration address allocation protocols may also allocate addresses that do not appear as reachable network destinations in the routing protocol. Routing protocols such as OSPF and IS-IS support the addition of new data types, thus allowing such information to be transported by the routing protocol. Importation of this information into the database of automatically configured address prefixes further reduces the potential for prefix collision.

Importing address allocation information from DHCP or BOOTP is generally more complex than snooping since the table of allocated addresses is likely to be located on a different network device to the device that wants to allocate an address. One method of importing address allocation information is to transport the list of addresses that are in use to the allocating device via a routing protocol. Numerous routing protocols support the tagging of prefixes with an identifier (in this case a full-length prefix specifying the actual address that has been allocated rather than a network prefix). Tagging the addresses in the routing protocol means that the addresses can be ignored by normal operation of the routing protocol. The address allocation server exports the list of allocated addresses into a routing protocol (e.g., OSPF) and tags the addresses as allocated addresses. A host or device attempting to perform a zero-configuration address allocation can consequently avoid the allocated addresses either by participating in the routing protocol to retrieve the list of allocated addresses, or by snooping on the routing protocol.

Zero-configuration address prefix allocation mechanisms or protocols such as zOSPF, which is an extended version of version 3 of the OSPF protocol, or Universal Identifier Allocation Protocol (UIAP), developed by Motorola, Inc., select addresses randomly from an available range and test for collisions. However, addresses can rather be selected based on knowledge of which address prefixes are already in use. Lists of existing allocations are imported from and exported to the routing protocol, which transports the information around the network zOSPF is a routing protocol that allocates address prefixes. While not itself a routing protocol, UIAP can make use of information obtained from a routing protocol to make better allocation decisions.

At step 120, an address is automatically selected and allocated such that an addressing conflict with the reachability information obtained in step 110 is avoided. The allocated address typically comprises an IP address or IP subnet address. Automatic selection and allocation of addresses means that no human input or supervision is required.

At step 130, the list of automatically allocated addresses is exported into the configured routing protocol as reachability information, typically as IP addresses or IP subnet addresses. Routing protocols announce reachability of a network prefix as a normal part of their operation. The allocated address can at a minimum be announced as reachable, hence announcing through the routing protocol that the address is in use. Additional information needs to be carried by the routing protocol for more reliable collision detection, most notably a unique label (such as an Ethernet MAC address or an EUI-64) that identifies the router that allocated each prefix. Existing routing protocols can be extended to carry this information. For example, IS-IS uses the TLV scheme and OSPF uses Opaque Link-State Advertisements (LSA's). The Opaque LSA option presents a general mechanism to allow for future extensibility of OSPF. The information contained in Opaque LSAs may be used directly by OSPF or by other protocols.

Thereafter, the zero-configured protocols engage in ongoing address collision detection and recovery. Address collisions tend to occur when two networks or sub-networks running zero-configuration protocols are merged. However, zero-configuration protocols can detect and resolve address collisions in a network. The actual mechanism used to detect collisions is defined by the specific zero-configuration protocol. A typical approach used is random selection of a candidate address prefix followed by broadcast of a small number of probe messages claiming the candidate prefix throughout the network. In address conflict situations, other network devices respond by sending a message rejecting the claim.

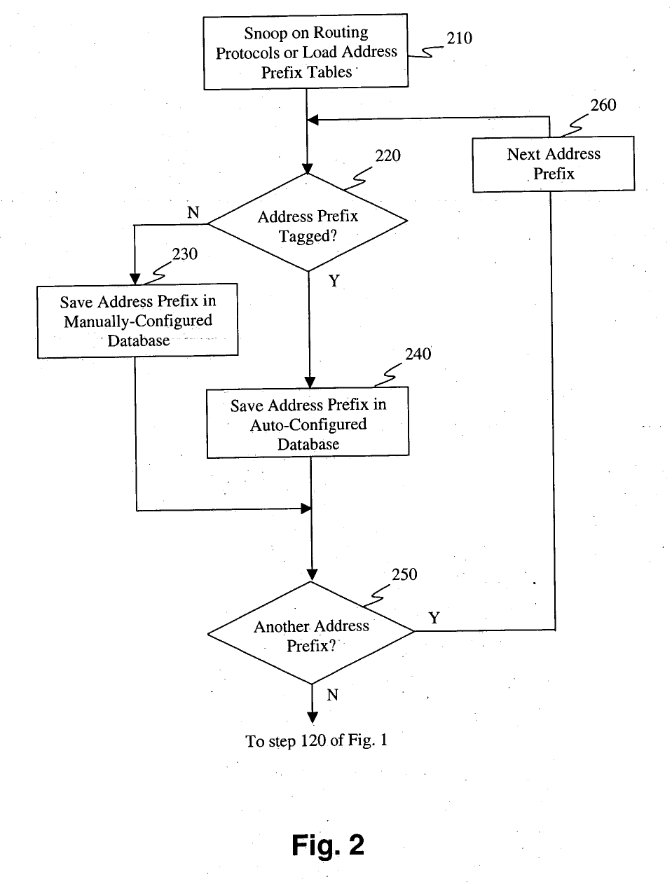

FIG. 2 is a flow diagram showing additional detail of step 110 of FIG. 1. At step 210, reachability information relating to the configured components in the network is obtained by snooping on the configured routing protocols, participating in the routing protocols, or loading address prefix information from a manual network address allocation mechanism. An example of the latter is loading DHCP lease tables from one or more network devices. A determination is made at step 220 whether each address prefix is tagged as auto-configured. Explicitly tagged address prefixes (Y) are saved in a database of auto-configured address prefixes at step 240. Non-tagged address prefixes (N) are stored in a database of manually-configured address prefixes at step 230. After steps 230 and 240, it is determined at step 250 whether more address prefixes need to be classified and saved. If so (Y), the next address prefix is selected at step 260 and processing then reverts to step 220. If not (N), processing continues at step 120 of FIG. 1.

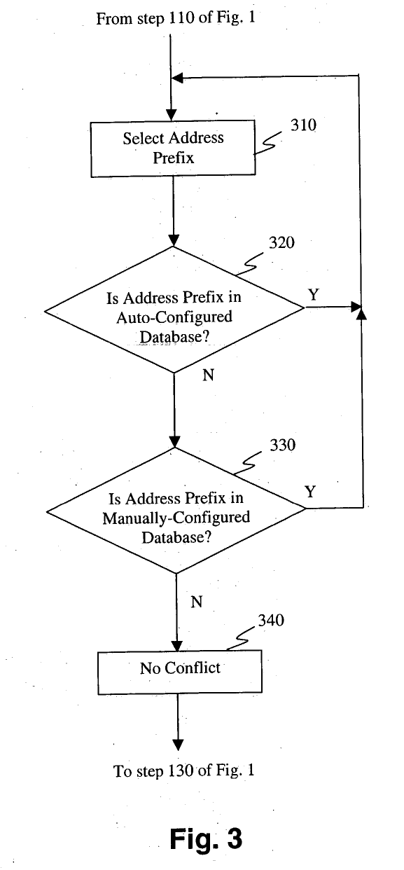

FIG. 3 is a flow diagram showing additional detail of step 120 of FIG. 1. At step 310, an address prefix is randomly selected from an available pool of address prefixes. A determination is made at step 320 whether the selected address prefix is contained in the database of auto-configured address prefixes. If so (Y), another address prefix is randomly selected at step 310. If not (N), a determination is made at step 330 whether the currently selected address prefix is contained in the database of manually-configured address prefixes. If so (Y), another address prefix is randomly selected at step 310. If not (N), the currently selected address prefix is assumed to be unused and no address conflicts are assumed to exist at step 340. Thereafter, processing continues at step 130 of FIG. 1.

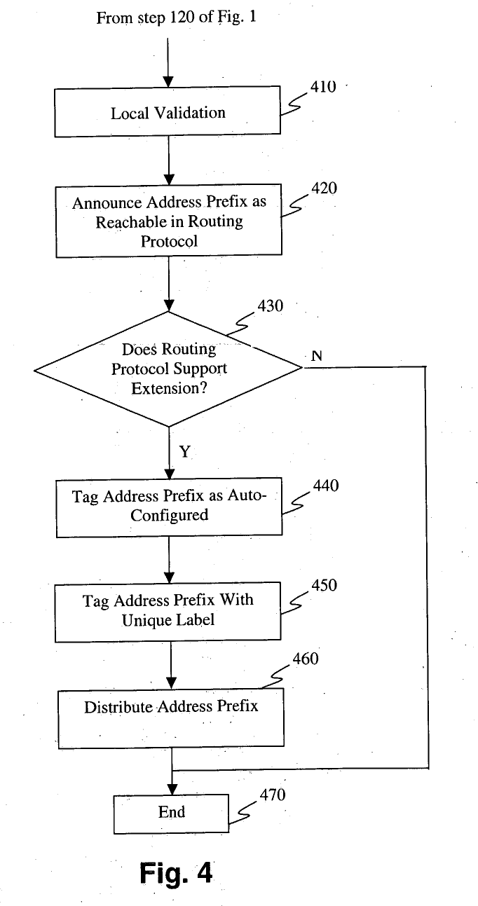

FIG. 4 is a flow diagram showing additional detail of step 130 of FIG. 1. At step 410, the address prefix selected in step 120 of FIG. 1 is locally validated using a zero-configuration protocol, if necessary. Then, the selected address prefix is announced as reachable in the routing protocol at step 420. At step 430, a determination is made whether the routing protocol supports an extension for tagging address prefixes. If so (Y), the address prefix is tagged as auto-configured at step 440 and tagged with a unique label that identifies the allocating router at step 450. Then the address prefix is distributed at step 460 using a routing protocol extension (e.g., OSPF Opaque LSA or IS-IS TLV) and processing terminates at step 470. If the routing protocol does not support an extension for tagging address prefixes, at step determination 430, processing terminates directly at step 470.

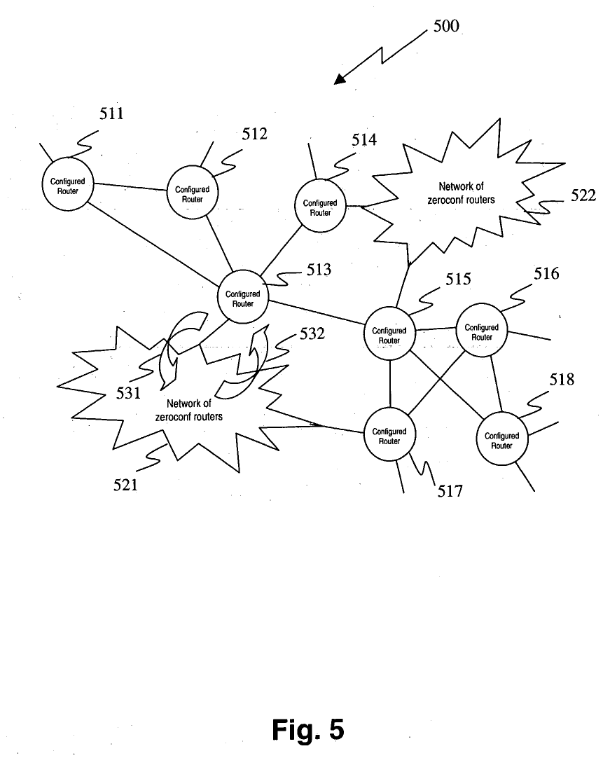

FIG. 5 shows a network environment including several configured routers 511 to 518 and two sub-networks or clouds of zero-configured routers 521 and 522 that are connected to certain of the configured routers 511 to 518. Specifically, network 521 is connected to configured routers 513 and 517 and network 522 is connected to configured routers 514 and 515. Integration or co-existence of the configured and zero-configured routers can be achieved by the routers in the zero-configured networks 521 and 522 allocating IP addresses or subnets in a manner such that collisions with existing subnet numbers in use on the network of configured routers 511 to 518 are avoided. Moreover, the IP subnets allocated in each of networks 521 and 522 are also allocated in a manner to avoid collisions with IP subnets in the other of networks 521 and 522.

Consider the case where the configured routers are running standard OSPF and the zero-configured routers are running a zero-configuration version of OSPF (zOSPF), which is an extension of OSPF version 3. Each zero-configured router sub-network 521, 522 imports reachability information 531 from the configured routing domain and avoids choosing subnet numbers that are already in use (i.e., subnet numbers that are reachable). Subnet numbers allocated in the zero-configured sub-networks 521, 522 are exported into the configured routing protocol as reachable destination addresses 532.

Subnet numbers can be exported to most routing protocols. However, certain routing protocols provide better communication between zero-configured router clouds. OSPF, for example, maintains a distributed database that describes the topology of the network and stores a variety of parameters. OSPF routers also maintain database entries for OSPF extensions that the routers do not support. Hence, a configured OSPF domain may serve as a distribution system allowing multiple zOSPF router clouds to communicate parameters other than basic reachability. Useful parameters are those that assist in the detection and resolution of addressing collisions (e.g., tagging prefixes as being automatically configured, and tagging the source router for a prefix).

Although not sanctioned by the Internet Engineering Task Force (IETF), the link-local address allocation mechanism in Internet Protocol version 4 (IPv4) can be used to allocate addresses in subnet ranges other than 169.254.xx.yy/16. The bottom two octets (xx.yy) can be randomly selected and probed using the Address Resolution Protocol (ARP) to determine whether an address is in use. However, this conflict detection mechanism only works if the host using the address is powered up and communicating.

In a configured network using DHCP as an address allocation mechanism, ranges of addresses can be set aside for groups of hosts. Many DHCP implementations do not check if an address is already in use when allocating from a configured pool. Hence it is possible that a zero-configuration address allocation mechanism operating in the same address space can allocate addresses that conflict with a DHCP allocation. Address ranges in use by DHCP can be distributed throughout the network to assist zero-configuration allocation mechanisms to avoid allocating addresses that may be assigned by DHCP to a different host.

In one embodiment, a DHCP server exports a summary of the address ranges that the server will be allocating from into a routing protocol like OSPF. The zero-configuration address allocation mechanism obtains information regarding the address ranges by participating in the routing protocol and can consequently avoid those address ranges.

In another embodiment, the zero-configuration routers automatically configure a local DHCP server to perform address allocation for non-link-local addresses.

In yet another embodiment, the zero-configuration router automatically configures a DHCP relay to a centralized address allocator.

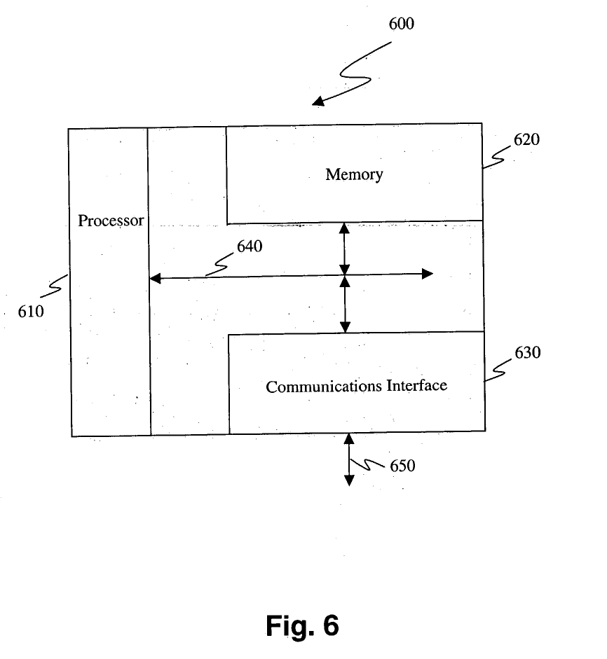

FIG. 6 is a block diagram of a network device or apparatus 600 such as an auto- or zero-configuration router, with which the methods of FIGS. 1 to 4 may be practised. The network device 600 includes a processor or computer 610 for executing one or more software programs to perform functions such as calculations and data storage and retrieval, a memory unit 620, for example formed from random access memory (RAM) and/or read only memory (ROM), and a communications interface 630. The processor 610 communicates with the memory unit 620 and the communications interface 630 via an interconnected bus 640 in a manner known to those in the relevant art. The network device 600 communicates with other network devices via the communications interface 630 and a network connection 650, also in a manner known to those in the relevant art.

In a particular embodiment, the network device 600 comprises a zero-configuration router for forwarding data packets in much the same fashion as a standard internet router but with an additional capability to automatically assign address prefixes to network links without operator intervention. Furthermore, additional software program functionality stored in the memory unit 620 and executed by the processor 610 provides for obtaining reachability information of configured network components, automatically selecting and allocating addresses and providing the automatically allocated addresses as reachability information to a routing protocol. As will be obvious to one skilled in the relevant art, other zero-configuration network devices such as a bridge can also be augmented in the same or a similar manner to the zero-configuration router described hereinbefore.

Assuming normal operating circumstances (i.e., no major packet loss on network links), collisions commonly result from the merging of two independent zero-configuration networks. The methods and devices described hereinbefore enable two separate zero-configuration clouds or networks separated by a non-zero-configuration network to co-ordinate address allocations such that address conflicts during merging of networks are eliminated or at least greatly reduced.

The methods and devices described hereinbefore further enable manual configuration of critical network components and simple (automatic) configuration of other network components, thus advantageously reducing network management costs.

The foregoing detailed description provides a preferred exemplary embodiment only, and is not intended to limit the scope, applicability or configurations of the invention. Rather, the description of the preferred exemplary embodiment provides those skilled in the art with enabling descriptions for implementing the preferred exemplary embodiment of the invention. It should be understood that various changes may be made in the function and arrangement of elements without departing from the spirit and scope of the invention as set forth in the appended claims.

We claim:

1. A method for allocating an address in an integrated network comprising at least one zero-configuration network component and configured network, said method comprising the steps of:
obtaining address reachability information relating to said configured components;
automatically allocating a network address that avoids an address conflict with reachability information obtained from said configured components; and
providing said allocated address to a routing protocol serving said configured network components.

2. The method of claim 1, wherein said address reachability information relating to said configured components is obtained by surveillance of a routing protocol.

3. The method of claim 1, wherein said address reachability information relating to said configured components is imported from an address allocation mechanism serving said configured network components.

4. The method of claim 1, wherein said step of automatically allocating a network address comprises allocating an IP address to a zero-configuration network component.

5. The method of claim 1, wherein said step of automatically allocating a network address comprises allocating an IP subnet prefix to a zero-configuration network component.

6. The method of claim 1, comprising the further step of detecting address collisions in said integrated network.

7. A communication network comprising a plurality of network components including at least one configured component having a manually configured address and at least one zero-configured component, wherein an address automatically allocated to said at least one zero-configured component does not conflict with said manually configured address.

8. The communication network of claim 7, wherein address reachability information relating to said at least one configured component is imported from a routing protocol in said network.

9. The communication network of claim 8, wherein said routing protocol comprises a protocol selected from the group consisting of:
Integrated Intermediate System To Intermediate System (ISIS);
Routing Information Protocol (RIP); and
Open Shortest Path First (OSPF).

10. The communication network of claim 7, wherein said manually configured address is imported from an address allocation mechanism in said network.

11. The communication network of claim 10, wherein said address allocation mechanism comprises a protocol selected from the group consisting of:
Dynamic Host Configuration Protocol (DHCP); and
Bootstrap Protocol (BOOTP).

12. The communication network of claim 7, wherein said automatically allocated address is provided to said at least one configured component and said at least one zero-configured component via a network routing protocol.

13. The communication network of claim 7, wherein said automatically allocated address is selected from the group consisting of:
a unique IP address; and
an IP subnet prefix.

14. The communication network of claim 7, wherein said at least one zero-configured component comprises a zero-configuration router.

15. An apparatus for automatically allocating a unique network address in a network, said network comprising components having manually allocated network addresses, said apparatus comprising:
a communications interface for obtaining and providing reachability information relating to components in said network; and
at least one processor for automatically selecting and allocating a network address that is different to manually allocated network addresses in said network and for providing information relating to said automatically allocated network address to a routing protocol serving said network.

16. The apparatus of claim 15, wherein said reachability information is obtained from a routing protocol in said network.

17. The apparatus of claim 15, wherein said reachability information is obtained from an address allocation mechanism in said network.

18. The apparatus of claim 15, wherein said automatically allocated network address comprises an IP subnet prefix.

19. The apparatus of claim 15, wherein said at least one processor detects address collisions in said network.

20. The apparatus of claim 15, wherein said apparatus is a zero-configuration router.
